(19) United States
(12) Patent Application Publication
(10) Pub. No.: US 2008/0107926 A1
(43) Pub. Date: May 8, 2008

(54) Fuel cell

(75) Inventors: Yoshinori Yamada, Aichi (JP); Hideki Hiraoka, Aichi (JP); Yoshinori Kimata, Aichi (JP)

Correspondence Address: KRATZ, QUINTOS & HANSON, LLP, 1420 K Street, N.W., Suite 400, WASHINGTON, DC, 20005, US

(73) Assignee: TOAGOSEI CO., LTD., Tokyo (JP)

(21) Appl. No.: 11/592,160

(22) Filed: Nov. 3, 2006

(51) Int. Cl. H01M 8/02

(52) U.S. Cl. 429/12

(57) ABSTRACT

A fuel cell is provided in which a unit comprising a unit cell and a current collector or a stack comprising a plurality of unit cells and current collectors is supported by an end plate, wherein the end plate employing a printed board having printed wiring on its surface.

### BACKGROUND OF THE INVENTION

1. Technical Field

The present invention relates to a fuel cell structure.

2. Description of the Related Art

A fuel cell is a device that generates an electromotive force by employing a gaseous or liquid fuel as a fuel and supplying oxygen or air as an oxidizing agent; it normally has a structure in which a proton-conducting electrolyte is sandwiched by electrodes containing an oxidation catalyst, and can give a desired electromotive force. The application of such a fuel cell to an electric automobile or stationary power generation has been expected; the development of practical applications is progressing and, in addition to these uses, the application to new uses is being investigated, utilizing the advantage that a reduction in weight and size is easy. For example, there is the use as a new power source in the replacement of existing dry batteries or rechargeable batteries in portable electrical appliances.

With regard to a small, lightweight fuel cell that can be used in a portable electric appliance, research has been carried out into various aspects, and selection is generally made from a system called a PEMFC, which employs hydrogen as a fuel, and a system called a DMFC, which employs a liquid fuel such as methanol. In a PEMFC, a mechanism for storing or generating hydrogen gas is essential, and there is the problem that the volume, weight, and cost of this mechanism are large. On the other hand, in a DMFC, there is no need to store or generate hydrogen gas, but since a catalytic oxidation reaction of a liquid fuel is slow, the output density is low, which is a problem, and it can be said to have merits and demerits. Although the present invention may be applied to either of these two systems, its desirable effects are particularly outstanding when it is used in a DMFC.

### DISCLOSURE OF THE INVENTION

### Problems to be Solved by the Invention

Since the theoretical power generation voltage of a fuel cell is 1.23 V whereas the working voltage of a general dry battery is 1.5 V, when a fuel cell is used as a replacement for a dry battery, it is necessary to connect a plurality of unit cells in series. In general, they are often used in a stack structure in which a separator is interposed between a plurality of unit cells, the separator being electrically conductive and allowing a fuel or gas to diffuse therethrough. The separator is made of an electrically conductive material such as a corrosion-resistant metal molding or a solid carbon block, and plays a role as a current collector that conducts the current that is generated by making intimate contact with an electrode of the fuel cell and that connects to external wiring, and a role of supplying a fuel or an oxidizing agent to a catalyst electrode by means of a flow path or diffusion employing a channel, etc. provided on the surface. The separator is generally required to have very high quality in terms of high precision, high rigidity, high corrosion resistance, low electrical resistance, etc., and there is therefore the problem that it is thick and heavy and has a high cost of as much as ⅓ of the production cost of a fuel cell main body.

As such a separator, one that is formed by subjecting a 4 mm thick stainless steel plate to a surface treatment is disclosed in, for example, JP-A-2001-250565 (Patent Publication 1) (JP-A denotes a Japanese unexamined patent application publication), but as described above it is thick and heavy and has a high cost.

### (Patent Publication 1) JP-A-2001-250565

On the other hand, end plates are disposed at opposite ends of a unit cell, or at opposite ends of the stack structure, in which the separator is interposed between a plurality of unit cells, and in order to apply a strong compression force evenly to the structure, the end plate is normally a plate having a large thickness and very high rigidity such as a thick special metal plate or an engineering plastic; machining is difficult, the cost of the material is high, and both the volume and weight are large, which are the main causes of the increase in overall cost and volume of the fuel cell.

The present invention has been proposed taking into account such conventional circumstances, and it is an object thereof to provide a small, lightweight, and inexpensive fuel cell, the fuel cell being capable of being connected in series without a high cost separator or end plate.

### BRIEF SUMMARY OF THE INVENTION

In order to achieve the above-mentioned object, the fuel cell of the present invention employs a printed board as an end plate, a fuel cell main body can be integrated with a peripheral circuit such as a terminal for electrical connection to an external circuit or wiring when connecting a plurality of unit cells in series, and the mechanical strength of the fuel cell main body and good contact with an electrode can be maintained by means of an inexpensive general-purpose material.

Furthermore, the present invention limits the surface roughness of a metal mesh to a specific value, thus guaranteeing good contact conductivity with a fuel cell electrode even under a relatively low pressure. As a result, a small, lightweight, and inexpensive fuel cell that gives a high output can be realized.

### BRIEF DESCRIPTION OF THE DRAWINGS

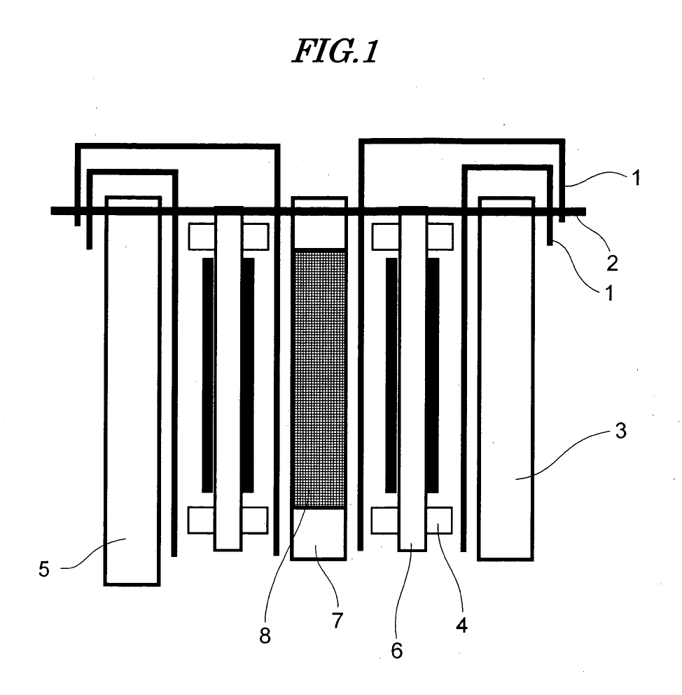

(FIG. 1) A sectional view illustrating one example of the fuel cell of the present invention.

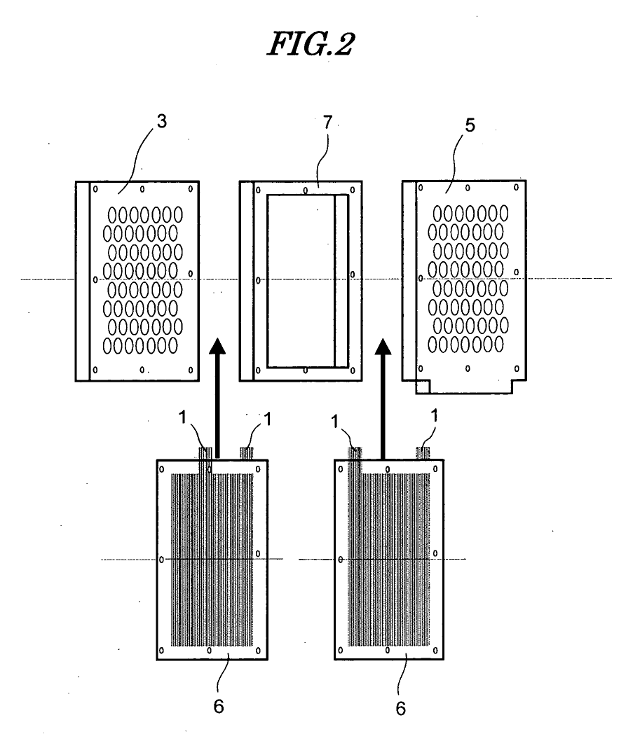

(FIG. 2) A front view of MEAs, end plates, and a fuel tank of a fuel cell having the structure shown in FIG. 1.

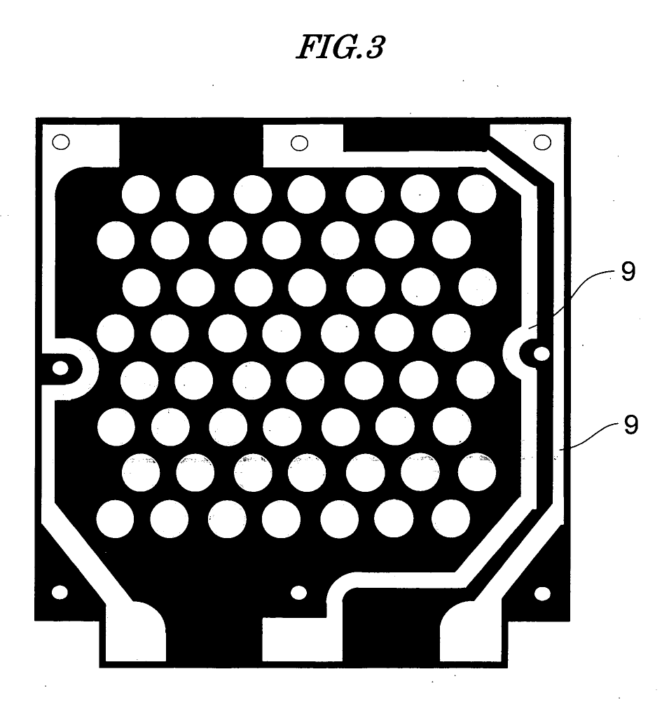

(FIG. 3) A front view of an end plate of the fuel cell with the structure shown in FIG. 1 on the surface of which a printed wiring pattern (areas shown in white in the peripheral region) is formed.

### EXPLANATION OF REFERENCE NUMERALS

### 1 Current collector

### 2 Securing screw

### 3 End plate

### 4 Gasket

### 5 End plate having printed wiring

### 6 MEA

### 7 Fuel tank frame

### 8 In-tank spacer

### 9 Wiring pattern

### BEST MODE FOR CARRYING OUT THE INVENTION

The fuel cell of the present invention is explained in detail below by reference to drawings.

FIG. 1 illustrates one example of the fuel cell of the present invention. In this example, two unit cells are disposed so as to face each other with the cathode side on the outside and a common fuel tank in the middle, and one end plate is a printed board having printed wiring on the surface. With regard to an MEA (electrolyte membrane equipped with a catalyst layer), which is inserted between the end plate at either end and the fuel tank in the middle, current collectors are in intimate contact with the cathode side and the anode side thereof, and end parts of the current collectors are connected to a circuit on the end plate.

FIG. 1 illustrates a combination of two unit cells, but it is also possible to form a cell from only one unit cell; in this case members on the left-hand side relative to the fuel tank (the MEA and the end plate on the left-hand side) are not needed, and instead a wall that prevents fuel within the fuel tank from leaking is provided on the left-hand side of the fuel tank. It is of course possible to form a stack by arranging the two unit cells in parallel instead of back-to-back or by putting three or more unit cells into intimate contact, and in such cases since, unlike the structure of FIG. 1, the cathode has a face that is not open to the outside air, it is preferable to provide the cathode with a flow path or a gap for supplying an oxidizing material such as air or oxygen.

With regard to a method for supplying a fuel and an oxidizing agent to the MEA, a system generally called a ‘passive type’ in which fuel and air are supplied by natural convection gives the lightest weight and the lowest cost, and this system is preferable for a small, lightweight fuel cell with relatively low power. On the other hand, it is also possible to employ a system called an ‘active type’ in which one or both of a fuel and an oxidizing agent are made to circulate by virtue of mechanical force or pressure. In this case, extra cost and energy for equipment for generating the mechanical force are needed and the fuel cell becomes large, but it is unnecessary to make the cathode open to the outside air, and a large amount of power can be taken out by superimposing a large number of cell units in intimate contact. The fuel cell of the present invention may suitably employ either of these systems, but it is preferable to employ the passive type since the features of small size, light weight, and low cost can be exploited.

Each of the two unit cells shown in FIG. 1 has one MEA incorporated thereinto. In this process, in order to prevent the fuel and oxidizing agent from leaking, it is possible to interpose a gasket or an O-ring between the two unit cells, provide a step in the fuel tank and the end plate, or apply a sealant.

FIG. 2 illustrates a structure in which a total of eight screw holes are opened in each member and the entirety is tightened by a fastening material such as a screw. As shown in FIG. 1, the screw runs through the entirety so as to fasten the end plates at opposite ends, and fastening one end of a preferred current collector to the end plate surface by means of the screw enables reliable contact of the current collector with printed wiring on the end plate surface. Furthermore, as shown in FIG. 2, by fastening given current collectors of two, that is, front and back cells, by means of the same screw the two cells can be connected in series or in parallel. That is, in some cases the screw has a function of fastening the plurality of unit cells or the stack as well as a function of being a part of the circuit. The screw may be made of a normal metal, or of a resin such as an engineering plastic or nylon if insulation is required.

It is also possible to use an adhesive instead of a screw for fastening. Although the adhesive does not have a function as a part of the circuit, or provide contact between the current collector and the printed wiring, when an appropriate adhesive is selected, utilizing its function of preventing leakage advantageously gives a small and lightweight cell. Although the adhesive is not particularly limited, it is preferable to use an epoxy- or polyester-based adhesive since it has high adhesion and chemical durability and it is stable for a long period of time even in contact with a fuel or an oxidizing agent.

A fuel tank frame shown in FIG. 1 is a member for retaining a fuel or making it flow, and a material that does not interfere with the fuel and is electrically insulating may be used. The frame and a gasket may be integral or separate. It is preferable to insert an in-tank spacer into the interior of the frame in order to oppose a pressure applied from the end plate to the MEA. The in-tank spacer may be one that is resistant to fuel, and may employ a polyethylene net, a plastic block into which a channel for fuel to flow is engraved, etc. The in-tank spacer may be integral with or separate from either the tank frame or the gasket, etc.

The MEA is formed from an electrolyte membrane with a catalyst layer and a diffusion layer on both sides thereof. The electrolyte membrane used may be one with proton conductivity; it is particularly preferable to use a perfluoroolefin-based ion-exchange membrane, represented by a Nafion (registered trademark) membrane manufactured by DuPont, or an ion-exchange membrane of a system in which pores of or a porous substrate are filled with a polymer with ion-exchangeability, and it is also preferable to use other hydrocarbon-based ion-exchange membranes or inorganic ion-exchange membranes, etc. The catalyst layer and the diffusion layer have generally known compositions and may be formed by standard methods.

With regard to a fuel cell having the above-mentioned configuration, the present invention is characterized by an end plate and a current collector. With regard to the end plate, as described above, a plate having a large thickness and very high rigidity such as a carbon block, a thick special metal plate and, in some cases, a polycarbonate or engineering plastic plate is conventionally used; machining is difficult, the cost of the material is high, and both the volume and weight are large, which are the main causes of the increase in overall cost and volume of the fuel cell.

In the present invention, a printed board is used as the end plate, printed wiring is formed on at least one end plate, light weight and low cost can thus be achieved, and by incorporating a peripheral circuit of the fuel cell into the cell main body, the reliability and the volume efficiency are improved. With regard to a printed board that can be used in the present invention, in addition to general-purpose standard products such as FR-4 (glass epoxy board), CEM-3 (glass composite board), FR-3 (paper epoxy board), and FR-1 (paper phenol board), a polyimide board, a PEEK (registered trademark) resin board, and a printed wiring board with a metal core, etc. may preferably be used in a similar manner.

As a method for forming printed wiring, a conventional patterning method for a metal-clad laminate such as a copper-clad laminate, etc. may preferably be used. Copper, aluminum, silver, gold, nickel, titanium, etc. metal wiring is formed on the surface of the board. An electronic component such as an LED or a resistor is mounted on the printed wiring formed on the end plate so as to display the amount of fuel remaining or voltage and current values, and it is also possible to form a converter for increasing the voltage, a stabilized power supply circuit for controlling the output, an auxiliary circuit for controlling supply of a fuel or an oxidizing agent, etc. Conventionally, these components are usually disposed at a different location from that for the fuel cell main body and connected via a lead, and the present invention therefore enables the number of components to be greatly decreased and the dimensions to be reduced. Furthermore, the integration and reliability can be further improved by a method in which the board is multilayered or resin-molded, etc.

As hereinbefore described, an end plate equipped with printed wiring has high utility value, but there is the problem that among the standard formats of printed board, which are used in large amounts at low cost as general-purpose products, there is no plate having a thickness of 4 to 100 mm, which has been used as an end plate in the art. The reason why a thick plate is used as the end plate is because tightening the entire fuel cell with a strong force gives a uniform contact surface pressure to the MEA and the separator or the current collector, thus reducing the contact resistance between a carbon layer on the MEA surface and the current collector.

Patent Publication 1 discloses a method in which, in order to reduce the contact resistance, the surface of a separator is coated with a metal having corrosion resistance, but its effect is not sufficient. In an example of this publication, it is disclosed that a stainless steel plate having a thickness of 4 mm is used and gold plating is carried out.

Furthermore, although in this publication a corrosion resistance effect is not demonstrated, there is the well-known problem that, in accordance with a solid plating method described in the above-mentioned method, pin holes remain and it is impossible to prevent the base material from being partially corroded, and this method cannot be said to be excellent in terms of corrosion resistance.

The first aspect of the present invention employs a printed board as an end plate; since a standard printed board format, which is generally distributed at a low price, has a thickness of 2 mm or less, and does not have the same rigidity as that of a stainless steel plate having a thickness of 4 mm as disclosed in, for example, Patent Publication 1, in order to achieve this rigidity it is necessary to specially prepare a thick printed board or superimpose a plurality of printed wiring boards.

However, by the use of a specific current collector in accordance with the second aspect of the present invention, a sufficiently low contact resistance can be realized by an end plate comprising a printed board having a thickness of 2 mm or less.

A current collector of a conventional normal fuel cell is a rigid separator with a flow path cut in the surface as disclosed in, for example, Patent Publication 1 above, and it employs a system in which it makes contact with an MEA through a face other than the flow path, and a fuel or an oxidizing agent is made to flow through the flow path.

On the other hand, the specific current collector referred to in the present invention is a metal mesh, and since the aperture area can be made large, sufficient flow of a fuel or an oxidizing agent can be obtained by virtue of diffusion without specially cutting a flow path.

Although a mesh current collector itself is already known, since the contact resistance is high, the generated power cannot be taken out efficiently unless the contact pressure with an MEA is increased considerably, with the result that the current collector cuts into the MEA, and a thick and highly rigid end plate is therefore essential.

As a result of an intensive investigation by the present inventors, it has been found out that, with regard to a mesh-like current collector with a smooth surface that is in contact with an MEA, the contact resistance is low without applying such a high contact surface pressure. Specifically, a current collector is used that has a mesh-like structure such as a punching metal, an expanded metal, or a wire netting and whose roughness on the surface that makes contact with the MEA is no greater than a predetermined value. Among these mesh-like current collectors, the punching metal has a limited aperture area and cannot have a very fine pattern for the aperture and the contact part; there is thus the problem that it is difficult to obtain a high output due to restrictions in conductivity and diffusion in the lateral direction on the surface of the MEA, but it may preferably be used by carrying out improvements such as cutting a channel in the surface or corrugating.

With regard to the wire netting, since it is woven, the contact surface has severe irregularities; in order to obtain a contact area a high contact pressure is required, and there is also the problem that conductivity within the wire netting in a direction perpendicular to the mesh pattern is poor, but it may preferably be used by squashing or welding the weave.

Therefore, the best mesh-like current collector is an expanded metal. As a material for these mesh-like current collectors, those having good corrosion resistance and good contact resistance with an MEA may be used. Gold and platinum, which have low contact resistance, are preferably used; whereas titanium in particular is corrosion resistant and has light weight and low price, it has a large contact resistance, and particularly remarkable effects can be obtained.

The specification of an expanded metal is defined in terms of plate thickness, line width, aperture ratio, etc. It is undesirable for the plate thickness to be too thin since the strength is insufficient or for it to be too thick since this results in heavy weight and high cost; the plate thickness is preferably 0.01 to 1 mm, and more preferably 0.05 to 0.5 mm. With regard to the line width, it is difficult to produce a very thin one, and it is preferably 0.02 to 1 mm, and more preferably 0.05 to 0.5 mm. The aperture ratio is preferably at least 50% but no greater than 95%, and more preferably at least 60% but no greater than 90%. The above-mentioned definitions are usual for expanded metal, and in addition thereto the present inventors have found that the contact resistance depends on the surface roughness of the contact area with the MEA, and by clarifying a preferred surface roughness the present invention has been accomplished.

A surface roughness preferred in the present invention is no greater than 10 μm as an arithmetic mean roughness (Ra), and more preferably no greater than 1 μm. The arithmetic mean roughness referred to here is defined in accordance with JIS B0901 (2001 edition), and is also defined as an arithmetic mean value of the size of irregularities for a standard length set in accordance with JIS B0633 (ibid). The surface of concern in the present invention is a contact surface between the current collector and the MEA, and the surface roughness, etc. on the side face of the current collector that does not make contact with the MEA is of no concern. The roughness of the actual surface may be measured by means of an atomic force microscope, a laser microscope, a contact type surface roughness meter, etc.

The reason why the contact resistance is influenced by the surface roughness of the current collector, and why an optimum value exists may be explained as follows.

When conduction is obtained by contacting the metal separator or the current collector with the MEA, it is a well-known fact that, if the contact surface pressure is less than a certain value, the contact resistance becomes very high, and this is clarified in Patent Publication 1 above. The reason therefor is that since the outermost surface of a material such as a separator or a current collector has micro irregularities that cannot be seen by the eye, the true contact area is smaller than an apparent contact area obtained by calculation. Furthermore, since carbon paper, carbon cloth, carbon paste, etc., which forms the surface of the MEA, has a very high roughness, the true contact area resulting from simply making the two come into contact with each other becomes very small, thereby increasing the contact resistance. It is therefore usual for them to be squashed with a strong surface pressure so as to increase the true contact area, but it has been found out that in accordance with the present invention a sufficient true surface area can be obtained even with a low surface pressure when the surface smoothness of the current collector is increased to a certain value or greater, and the contact resistance becomes low.

The present invention can give a fuel cell that has a small size, light weight, low cost, and high reliability at the same time since a peripheral circuit can be mounted on the fuel cell main body due to the use of a printed board as an end plate and, furthermore, can employ a thin end plate since contact resistance is low even at a low surface pressure due to the use of a current collector having an appropriate surface configuration in a fuel cell.

### EXAMPLES

Preferred embodiments of the present invention are explained below as Examples while comparing them with Comparative Examples.

### Example 1

A fuel cell having the structure shown in FIG. 2 was actually prepared and the effects thereof were demonstrated. The end plate shown in FIG. 2 was an FR-4 board having a square shape with a long side of 66 mm and a thickness of 2 mm, and holes were made by drilling. With regard to the drilled holes, eight holes having a diameter of 2.2 mm were formed in the peripheral region for assembly, and 56 holes having a diameter of 5 mm were formed as through holes for outside air in a portion positioned on the surface of a cathode electrode of an MEA.

An end plate with a circuit in FIG. 2 employed an FR-4 copper-clad laminate in which copper foil having a thickness of 100 μm was affixed to an outer face of an irregular rectangular shape having a length of 75 mm and a width of 66 mm and a thickness of 2 mm, and a copper foil circuit with the patterning shown in FIG. 3 was used.

As a fuel tank frame of FIG. 2, one formed by machining an acrylic plate having a thickness of 3 mm into a frame shape was used, and a polyethylene net having a thickness of 4 mm was inserted into the frame.

With regard to the MEA, an electrolyte membrane was formed by filling a polyethylene porous membrane with an electrolyte polymer containing as main components 2-acrylamido-2-methylpropanesulfonic acid and N,N′-methylenebisacrylamide, an oxygen electrode and a fuel electrode were prepared by screen-printing carbon paper having an area of 25 cm² respectively with a reaction layer coating solution containing a platinum-supporting carbon and a reaction layer coating solution containing a platinum ruthenium alloy-supporting carbon, and these were then hot-pressed to either side of the electrolyte membrane to give an MEA.

A titanium expanded metal current collector having a thickness of 0.1 mm was superimposed on either side of the MEA, a polyethylene net having a thickness of 0.5 mm was further superimposed on the expanded metal in order to adjust the surface pressure, and the entirety was interposed between end plates and tightened by means of eight M2×12 mm screws. At this stage, the mean surface pressure of the entire contact surface was 1 kg/cm². A titanium plate having a thickness of 0.05 mm and a width of 8 mm was welded to the current collector, and fastened to a printed circuit on the circuit-equipped end plate via a screw (M2×12 mm) for tightening the main body as a lead for taking electricity out of the cell.

The expanded metal was formed by subjecting a 0.1 mm thick titanium plate to an expanding process and then a flattening process in order to optimize irregularities on the surface to thus squash the irregularities, and when the surface roughness was measured using an atomic force microscope (AFM), Ra was 0.08 μm for a length of 20 μm. The measurement is a mean value of figures obtained with n=5 for the contact surface with the MEA while avoiding end faces and obvious scratches.

The interior of the tank of the fuel cell thus formed was filled with 6 mL of a 3 mol/L aqueous solution of methanol, and air was used as an oxidizing agent. When the I-V characteristics were measured, 1.2 V was obtained for 0.68 A, and a maximum output of 0.41 W per unit cell was obtained at 30° C. Subsequently, when the fuel cell was inserted into a socket of a commercial portable electric appliance equipped with a socket for a printed board, it could be made to operate well, and when fuel replacement, etc. was required, the fuel cell main body was removed from the socket, and maintenance could thus be carried out easily.

### Comparative Example 1

A fuel cell was prepared in the same manner as in Example 1 except that the expanded metal for the current collector of Example 1 was not subjected to the flattening process although the specifications for the material and the dimensions were the same, and neither of the end plates at opposite sides was equipped with a printed circuit. The lines of the net of the current collector that had not been subjected to the flattening process made obliquely twisted contact with the surface of the MEA, there was no flat contact area, the roughness was too high, and measurement using AFM could not be carried out. According to measurement was carried out using a surface roughness meter, the roughness was 67.4 μm for a length of 4 mm with n=5.

When the maximum output per unit cell of this fuel cell was measured by the same method as in Example 1, it was a very low value of 0.13 W. It is surmised that this is due to a high contact resistance between the current collector and the MEA. Furthermore, since titanium, which was the material for the current collector and the lead, could not be soldered, a circuit was formed by compression-bonding a commercial insulated copper wire to the lead with a compression bonding terminal and it was mounted on a portable electric appliance that was the same as that in Example 1 except that it was not equipped with a socket, but mounting was very difficult, when fuel was replaced the spent fuel needed to be discharged by turning the portable electric appliance upside down, and the operability was very poor.

### INDUSTRIAL APPLICABILITY

The fuel cell of the present invention gives a low contact resistance even at a low surface pressure by employing a current collector having an appropriate surface configuration, it is therefore possible to employ a thin end plate and, furthermore, since a peripheral circuit can be mounted on a fuel cell main body by using a printed board as the end plate, it is possible to achieve small size, light weight, low cost, and high reliability at the same time.

By exploiting the above-mentioned characteristics, this fuel cell is very useful as a new power source as a replacement for an existing dry battery or rechargeable battery, particularly in a portable electric appliance.

What is claimed is:

1. A fuel cell in which a unit comprising a unit cell and a current collector or a stack comprising a plurality of unit cells and current collectors is supported by an end plate, the end plate employing a printed board having printed wiring on its surface.

2. The fuel cell according to claim 1, wherein the current collector is a metal mesh having a surface roughness, as an arithmetic mean roughness, of a surface in contact with a catalyst layer or a diffusion layer in the unit cell of no greater than 10 μm.

3. The fuel cell according to claim 1, wherein the current collector is a metal mesh having a surface roughness, as an arithmetic mean roughness, of a surface in contact with a catalyst layer or a diffusion layer in the unit cell of no greater than 1 μm.

4. The fuel cell according to claim 1, wherein the current collector is a metal mesh.

5. The fuel cell according to claim 1, wherein the current collector is a perforated metal, an expanded metal, or a wire netting.

6. The fuel cell according to claim 1, wherein the current collector is an expanded metal.

7. The fuel cell according to claim 4, wherein a material for the metal mesh is gold, platinum, or titanium.

8. The fuel cell according to claim 4, wherein a material for the metal mesh is titanium.

9. The fuel cell according to claim 1, wherein the printed board has a thickness of 2 mm or less.

10. The fuel cell according to claim 1, wherein the printed board is a printed board using a glass epoxy board, a glass composite board, a paper epoxy board, a paper phenol board, a polyimide board, a PEEK (registered trademark) resin board, or a printed wiring board with a metal core.
